(19) United States
(12) Patent Application Publication
(10) Pub. No.: US 2007/0077544 A1
(43) Pub. Date: Apr. 5, 2007

(54) Life-like anatomic feature for testing injection of soft tissue fillers

(76) Inventors: Gottfried Lemperle, San Diego, CA (US); William J. Seare JR., Carlsbad, CA (US); Russell Anderson, San Diego, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/454,539

(22) Filed: Jun. 16, 2006

Related U.S. Application Data
(60) Provisional application No. 60/691,454, filed on Jun. 16, 2005.

(51) Int. Cl. G09B 23/28

(52) U.S. Cl. 434/262

(57) ABSTRACT

Provided are life-like anatomic features, including face masks, for the practice or demonstration of injection of soft tissue filler and methods relating to same.

### REFERENCE TO PRIORITY DOCUMENT

This application claims the benefit of priority of U.S. Provisional Patent Application Ser. No. 60/691,454 entitled “LIFE-LIKE MASK FOR TESTING INJECTION OF DERMAL FILLERS”, by Gottfried Lemperle and William Seare, filed Jun. 16, 2005, herein incorporated by reference.

### BACKGROUND OF THE INVENTION

1. Field of the Invention

The present invention relates generally to devices simulating biomechanical characteristics of animal anatomic features and methods using same.

2. Description of the Related Art

Soft tissue fillers can be used for augmenting tissue structures, particularly soft tissues, within an animal body. For example, soft tissue fillers can be used to bulk up sphincter muscles to enhance sphincter function, such as injecting a soft tissue filler in and/or around the lower esophageal sphincter in order to treat gastroesophogeal reflux disease (GERD). Skin defects can be corrected by injecting soft tissue fillers, also called dermal fillers, into the skin to fill the defects. Some skin defects that can be treated by injection of dermal fillers include, but are not limited to, filling wrinkles and folds in the face, augmenting lips, correcting irregularities of the nose, and eliminating acne scars.

ArteFill® or other collagen-based materials or other injectables are commonly used as soft tissue fillers. ArteFill® is a trade name for a tissue filler comprising approximately 20% by weight polymethylmethacrylate (PMMA) and approximately 80% by weight of a composition of 3.5% purified bovine collagen, 2.7% phosphate buffer, 0.9% sodium chloride, 0.3% lidocaine hydrochloride, and 92.6% water for injection. Examples of other microsphere-based filler materials are disclosed in U.S. Pat. No. 5,344,452, which issued on Sep. 6, 1994, herein incorporated by reference.

Accurate placement of soft tissue fillers within or around an anatomic feature can require substantial training and practice. This can be particularly true for obtaining aesthetically pleasing results when injecting a dermal filler or when attempting to inject soft tissue filler in deep tissue structures, such as sphincter muscles. It is clearly desirable to avoid practicing on human subjects. One substitute is a body or body part of a non-human animal subject, but there are drawbacks. A synthetic anatomic feature can be a more accurate, more convenient, more ethically satisfactory and less expensive substitute to a non-human animal subject. Unfortunately, when soft tissue fillers are injected into, for example, a conventional synthetic mask, the synthetic material may have a tendency to push the soft tissue filler back out of the mask, as a result of the synthetic material having a memory.

Unlike such synthetic materials, skin and other body tissues do not have as much of a tendency and/or as high of a degree of memory. Accordingly, dermal fillers that are injected into natural skin, for example, may not be ejected to the same extent as when injected into a conventional synthetic mask. The practitioner who injects dermal fillers into a conventional synthetic mask may therefore encounter complications, or different effects or responses, that would not be observed when injecting dermal fillers into the natural skin of a subject. At least as far as the aspect of ejecting injected dermal fillers, conventional synthetic masks may not be optimal models for injection of dermal fillers into natural skin.

Thus, there is a need for a life-like anatomic feature that responds to injections of soft tissue fillers in a manner that is more similar to the behavior of the corresponding anatomic feature than that for conventional synthetic products. The present invention satisfies these needs and provides further advantages.

### SUMMARY

In accordance with the invention, a life-like anatomic feature comprising low memory synthetic material is provided. Life-like anatomic features such as a face, a sphincter, a heart muscle, a structure that makes a body lumen (e.g. a blood vessel, a duct, a bronchus, a lung, a sinus, an esophagus, a stomach, a duodenum, a small intestine, a large intestine, a colon, a rectum, a ureter, a urethra, a vagina, a fallopian tube), soft tissues of a joint, and soft tissue between vertebra are provided. The low memory synthetic material can be silicone rubber. The silicone rubber can be made by mixing a silicone base with a catalyst and the catalyst can be tin, platinum, gum elastomers or peroxides. The silicone rubber can include a cross-linker and the cross-linker can be silane-based.

In another aspect of the invention, a life-like anatomic feature having an absorbent is provided. The absorbent can be one or more of glass fibers, carbon fibers, sand, salt, gas, foaming agents, and sugar.

In another aspect of the invention, a life-like anatomic feature made of at least two layers is provided. In yet another aspect of the invention, a life-like anatomic feature made of at least three layers is provided.

In another aspect of the invention, a life-like anatomic feature is provided with at least one pigment or dye, such as to simulate the coloration of the corresponding anatomic feature or to provide visual boundaries between structures. In another aspect of the invention, a life-like anatomic feature is provided with a coating, such as a clear coat, such as to enable the practitioner to gauge the depth of the insertion and placement of filler materials.

In another aspect of the invention, a life-like anatomic feature, such as a life-like mask, having at least one representative skin defect is provided, wherein the skin defect can be, for example, a wrinkle, a fold, a thin lip, an irregularity of the nose, or an acne scar.

In another aspect of the invention, a method is provided for practicing using a soft tissue filler by injecting a soft tissue filler into a life-like anatomic feature having low memory synthetic material and monitoring the change of the conformation of said life-like anatomic feature. In another aspect of the invention, a method is provided for practicing using a dermal filler by injecting a dermal filler into a face mask having low memory synthetic material and monitoring the change of the surface of said face mask. The method can be performed using silicone rubber, wherein the silicone rubber can be made by mixing a silicone base with a catalyst. The catalyst can be tin, platinum, a gum elastomer, or a peroxide. The silicone rubber can include a cross-linker, and the cross-linker can be silane-based.

In another aspect of the invention, a method is provided for practicing using a soft tissue filler by injecting a soft tissue filler into a life-like anatomic feature having low memory synthetic material and monitoring the change of the conformation of said a life-like anatomic feature and where the life-like anatomic feature includes an absorbent. In another aspect of the invention, a method is provided for practicing using a dermal filler by injecting a dermal filler into a face mask having low memory synthetic material and monitoring the change of the surface of said face mask and where the life-like mask includes an absorbent. The absorbent can be, for example, one or more of glass fibers, carbon fibers, sand, salt, sugar, gas, or foaming agent.

In another aspect of the invention, a method of using a life-like mask having at least one representative skin defect is provided, wherein the skin defect can be, for example, a wrinkle, a fold, a thin lip, an irregularity of the nose, or an acne scar.

In another aspect of the invention, a method for practicing or demonstrating the use of a soft tissue filler by using a life-like anatomic feature and a soft tissue filler having polymethylmethacrylate (PMMA) microspheres is provided. A method for practicing or demonstrating the use a soft tissue filler by using a life-like anatomic feature using a soft tissue filler, such as ArteFill®, is also provided.

### BRIEF DESCRIPTION OF THE DRAWINGS

FIG. 1 is a life-like mask.

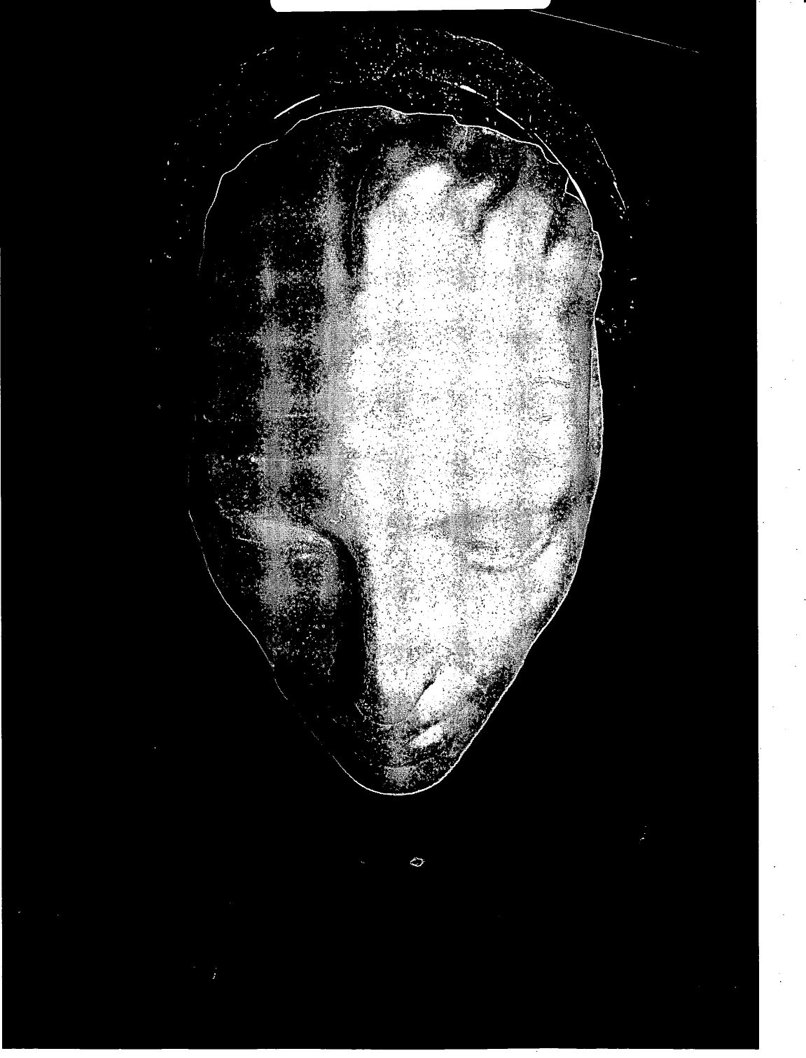

### DETAILED DESCRIPTION

Life-like anatomic features made of low memory synthetic material, such as silicone rubber or similar materials in modified embodiments, have been developed in accordance with the present invention for allowing a practitioner to practice and demonstrate injection techniques with the life-like anatomic feature before a practitioner injects soft tissue fillers into a subject. Practicing the injection techniques with life-like anatomic features rather than a subject, and/or viewing demonstrations thereof, will generally provide the subject with a higher quality result than if the practitioner had not practiced, or viewed the practice, with a life-like anatomic feature prior to treating the subject.

A subject can be an animal. An animal can be a mammal. A mammal can be a human.

A low memory synthetic material is one that has a lowered propensity to regain its shape upon deformation, such as by injection of another material. As disclosed, a low memory synthetic material will have a lowered propensity for ejecting material injected therein, thereby more accurately simulating the injection of animal soft tissues with filler material.

A life-like anatomic feature can represent any soft tissue portion of a subject, or part thereof. The life-like anatomic feature can represent a muscle. The muscle can be striated or smooth. The muscle represented can be a sphincter muscle. The sphincter muscle represented can be, for example, anal, urinary, bladder, pyloric, or lower esophageal sphincter.

The life-like anatomic feature can represent a body lumen, such as a blood vessel, a duct, a bronchus, a lung, a sinus, an esophagus, a stomach, a duodenum, a small intestine, a large intestine, a colon, a rectum, a ureter, a urethra, a vagina, a fallopian tube, and the like. The represented body lumen can be have a defect, such as a tear or prolapse.

The life-like anatomic feature can represent the soft tissue surrounding a joint, such as a a temporomandibular joint, a shoulder, an elbow, a wrist, a finger joint, a hip, a knee, an ankle, or a toe joint, and the like

The life-like anatomic feature can represent the soft tissue between vertebrae. The life-like anatomic feature that can represent the soft tissue between vertebra can be formed to simulate disc injury that includes annular tears with herniation of the nucleus pulposus (soft disc herniation) or annular tear without herniation of the nucleus pulposus (ie, internal disc disruption). Methods for treating disc injuries using soft tissue fillers is described in U.S. Patent Publication No. 2006/0074424, entitled “Method of Treating a Spinal Internal Disc Derangement”, herein incorporated by reference.

A life-like anatomic feature can be a face mask, which can represent the entire or a portion of the face. The partial mask can be the upper portion of a face, the lower portion, the right side or the left side. The partial mask can be a single feature, a combination of features, or a feature and its surrounding area such as a lip, a mouth, a nose, an eye, both eyes, an ear, a chin, a cheek, a forehead, and the like.

The life-like mask can include one or more skin defects such as a wrinkle, a fold, a thin lip, an irregularity of the nose, or an acne scar. A wrinkle can take the form of a small ridge, a depression or furrow in the skin especially when due to age, poor skin care, or fatigue.

A mold can be made of an anatomic feature, or a sculptural representation thereof, using a molding compound, such as Plaster of Paris, and then a life-like anatomic feature can be made of low memory synthetic material using said mold in a casting process. Alternatively, the exterior contours of a life-like anatomic feature can be sculpted and a life-like anatomic feature can be made of low memory synthetic material using said sculpture as a cast. Additional features can be added to the mold or the cast to simulate lines, grooves, depressions and the like. Surfaces of the various molds contacting the low memory synthetic material can optionally be coated with a material that limits sticking of the low memory synthetic material to the contact surface, such as Vaseline. Various methods of casting are known to those skilled in the art. Synthetic materials, such as silicone elastomers, can be molded into cured configurations by compression, transfer or, if a liquid synthetic material, injection molding processes. Synthetic materials, such as silicone elastomers, can be molded by dip casting processes.

The life-like anatomic feature can be made with, at least in part, silicone rubber. Silicone rubber can be made, for example, by mixing a silicone base with a catalyst. According to an embodiment of the present invention, the catalyst can comprise a platinum catalyst. In a modified embodiment, the catalyst can comprise a tin catalyst, which may be less expensive and more forgiving of impurities as compared to a platinum catalyst. The silicone rubber that is prepared with a platinum cure catalyst, on the other hand, may last longer and/or exhibit a greater durability. In a representative embodiment, the platinum cure catalyst can be purchased from NuSil Technologies in Carpinteria, Calif. The catalyst can be a peroxide catalyst. The peroxide catalyst can be, for example, methyl ethyl ketone peroxide, benzyol peroxide or acetone peroxide. The catalyst can be a gum elastomer. The catalyst can be from 0.5 to 1%. The catalyst can be more than 1%, more than 2%, more than 3%, more than 4%, more than 5%, more than 6%, more than 7%, more than 8%, more than 9%, more than 10%, more than 12%, more than 14%, more than 16%, more than 18%, or more than 20%. Other catalyst or combinations known to the skilled artisan may be implemented in modified embodiments.

Platinum catalyzed silicones, also known as addition cured silicone elastomers, are generally two component systems, which can be formulated in a ratio 1:1, 2:1, 3:1, 4:1, 5:1, 6:1, 7:1, 8:1, 9:1, or 10:1 A:B. Typically, Part A component contains vinyl polymer functional silicones and the platinum catalyst, whereas Part B contains vinyl functional polymer, hydrogen-functional cross-linker, and cure inhibitor. Cure inhibitors are additives used to adjust the cure rate of the system. Other component combinations are possible and known to those skilled in the art.

Vulcanization of addition cured silicone elastomers can be heat accelerated and fully cured at temperatures and times ranging, for example, from 10 minutes at 116° C. to 2 minutes at 150° C., depending on product mass and presence of contaminants that inhibit catalysis. Longer times at lower temperatures can also be performed.

A silicone life-like anatomic feature can be subjected to post-curing steps, known to those skilled in the art, to remove volatile components and other residuals and to stabilize and enhance the physical properties of the silicone elastomer. Post-curing can be accomplished by heating the vulcanized material in a hot air circulating oven. The time required for post-curing depends on the rate of volatilization, which depends upon the thickness of the life-like anatomic feature, the exposed surface area, and the oven loading. Curing conditions are determined empirically by methods typical in the art. For example, a standard ASTM slab (1.9 mm thick) should be post-cured at 177° C. for a minimum for 2 hours or 200° C. for a minimum of 1.5 hours for peroxide catalyzed elastomer systems.

According to one embodiment of the present invention, a life-like anatomic feature can comprise silicone rubber that has been modified to contain at least one absorbent, or to contain a relatively high percentage by weight of absorbent as compared to an amount that may be conventionally or typically used for similar applications. The absorbent can comprise at least one of glass fibers, carbon fibers, sand, salt, sugar, a gas, or foaming agent. The gas can be any non-reactive gas such as air, argon, carbon dioxide, and the like. The foaming agent can include, but not limited to, esters and styrenes. The foaming agent can be admixed with one or more gases to create a foam. The absorbent can make the silicone rubber less apt to eject injected dermal fillers as compared to conventional silicone rubber or other synthetic materials. For example, the life-like rubber masks that are prepared with silicone rubber or other synthetic material that comprise at least one absorbent may be better models for injection of dermal fillers into natural skin than are conventional synthetic masks. Absorbents can be mixed with the silicone rubber or other synthetic material, or a component thereof. Absorbents can be added after curing of the synthetic material or between layers of the silicone rubber or other synthetic material.

According to another embodiment of the present invention, a life-like anatomic feature may comprise silicone rubber that has been modified to contain a cross-linker, or an altered amount of cross-linker such as a relatively high percentage by weight of cross-linker as compared to an amount that may be conventionally or typically used for similar constructs. Silicone rubber can be cross-linked in the presence of the catalyst by the catalyzed addition of, for example, a silane group (—Si—H) in the cross-linker to terminal vinyl groups in the silicone base material. In a modified embodiment of the present invention, the amount of cross linker may be reduced from an amount that is conventionally used. In an embodiment of the present invention, reducing the amount of cross-linker that may be utilized to form the silicone rubber that may be formed into a life-like anatomic feature can reduce the tendency of the silicone rubber to eject injected dermal fillers, as compared to life-like anatomic features formed from conventional synthetic materials.

In yet another embodiment, the cross-linker for forming silicone rubber for a mask may comprise a silane-based material. Other cross-linkers types and proportions may be employed in alternative embodiments.

In another embodiment, the amount of absorbent in the silicone rubber is increased and the amount of cross linker is reduced from amounts that are used to form conventional silicone rubber.

In another embodiment, the life-like anatomic features according to embodiments of the present invention are formed in 2 or 3 layers rather than a single layer to better mimic the corresponding tissues, such as the skin and sub dermal layers.

In another embodiment, a life-like anatomic feature has at least one pigment or dye, such as to simulate the coloration of the corresponding anatomic feature or to provide visual boundaries between structures. Pigments include biological and organic pigments and inorganic pigments.

Biological and organic pigments include heme/porphyrin-based pigments, light-emitting pigments, lipochromes, carotenoids, xanthophylls, photosynthetic pigments, resins, polyene enolates, and others. Heme/porphyrin-based pigments include chlorophyll, bilirubin, hemocyanin, hemoglobin, and myoglobin. Light-emitting pigments include luciferin. Carotenoids include alpha and beta carotene, anthocyanin, lycopene, and rhodopsin. Xanthophylls include canthaxanthin, zeaxanthin, and lutein. Photosynthetic pigments include chlorophyll and phycobilin. Organic pigments include Pigment Red 170, phthalocyanine, Phthalo Green, Phthalo Blue, Alizarin, Alizarin Crimson, crimson, Indian Yellow, indigo, quinacridone, Quinacridone Magenta, and woad. Resin includes gamboge. Other pigments include hematochrome, melanin, Phthalocyanine blue, urochrome, and Van Dyke brown.

Inorganic pigments include carbon pigments, cadmium pigments, iron pigments, chromium pigments, cobalt pigments, lead pigments copper pigments, itanium pigments, sulfur pigments, chrome pigments, zinc pigments, clay earth pigments. Carbon pigments include bone black (also known as bone char), carbon black, ivory black, vine black, lampblack, and Mars black. Cadmium pigments include Cadmium Green, Cadmium Red, Cadmium Yellow, and Cadmium Orange. Iron pigments include Caput Mortuum, Prussian blue, oxide red, red ochre, Sanguine, and Venetian red. Chromium pigments include Chrome Green and chrome yellow. Cobalt pigments include cobalt blue and cerulean blue. Lead pigments include lead white, Naples yellow, Cremnitz White, Foundation White, and red lead. Copper pigments include Paris Green and verdigris. Titanium pigments include titanium dioxide and titanium white. Sulfur pigments include ultramarine, Ultramarine Green Shade, French Ultramarine, and vermilion. Chrome pigments include viridian. Zinc pigments include zinc white. Clay earth pigments include sienna, raw sienna, burnt sienna, umber, raw umber, burnt umber, and yellow ochre

Dyes can be food dyes. Food dyes can be direct, mordant or vat dyes.

In another embodiment, a life-like anatomic feature has a coating, such as a clear coat, such as to enable the practitioner to gauge the depth of the insertion and placement of filler materials.

Injection techniques can be demonstrated with or practiced upon the disclosed life-like anatomic features. A life-like anatomic feature can be made with a low memory material, optionally containing an absorbent, wherein filler material can be injected. A practitioner can monitor how a filler material fills a region below the surface of the life-like anatomic feature or how the filler material alters the surface of the life-like anatomic feature, or both. Monitoring can be done by another method of visualization known in the art, such as by merely visually observing the filling under or on the surface of a translucent or transparent life-like anatomic feature. As another example, a radio-opaque agent can be included with the filler material and radiography can be used to monitor placement of the material during or after injection into the life-like anatomic feature, even if the life-like anatomic feature is not translucent or transparent.

In another embodiment, a practitioner can inject a life-like face mask with a dermal filler and monitor placement of the dermal filler under the surface of the life-like face mask or monitor the alteration of the surface or both. The practitioner can inject dermal filler into a representative skin defect, such as creases, lines, depressions, or furrows that represent wrinkles, in order to practice or to demonstrate wrinkle filling technique.

In another embodiment, a practitioner can inject a life-like muscle, which can be striated or smooth, and monitor placement of the filler material under the surface of the life-like muscle or monitor the alteration of the surface or both. The life-like muscle can be a life-like sphincter muscle. The sphincter muscle represented can be, for example, anal, urinary, bladder, pyloric, or lower esophageal sphincter. The practitioner can inject filler materials into regions that represent malfunctioning muscle in order to practice or to demonstrate tissue bulking technique or tissue repair localization.

In another embodiment, a practitioner can inject a life-like body lumen, representing a blood vessel, a duct, a bronchus, a lung, a sinus, an esophagus, a stomach, a duodenum, a small intestine, a large intestine, a colon, a rectum, a ureter, a urethra, a vagina, a fallopian tube, and the like. The represented body lumen can be have a defect, such as a tear or prolapse. The practitioner can inject filler materials into regions that represent a defective lumen or a lumen where it is desired to block flow or support structure in order to practice or to demonstrate tissue repair localization or embolization.

In another embodiment, a practitioner can inject a life-like soft tissue component surrounding a joint, such as a temporomandibular joint, a shoulder, an elbow, a wrist, a finger joint, a hip, a knee, an ankle, or a toe joint, and the like. The practitioner can inject filler materials into regions that represent a defective joint in order to practice or to demonstrate tissue repair localization.

In another embodiment, a practitioner can inject a life-like soft tissue component between vertebrae. The life-like anatomic feature that can represent the soft tissue between vertebra can be formed to simulate disc injury that includes annular tears with herniation of the nucleus pulposus (soft disc herniation) or annular tear without herniation of the nucleus pulposus (ie, internal disc disruption). The practitioner can inject filler materials into regions that represent a defective nucleus pulposus in order to practice or to demonstrate tissue repair localization or tissue bulking.

As a life-like anatomic feature can have several surfaces, the above methods can be performed multiple times on a single life-like anatomic feature by practitioners for several practice or demonstration sessions. In certain embodiments, injected filler can potentially be removed by withdrawal by syringe and the anatomic feature reused.

### EXAMPLE 1

### Preparation of a Life-Like Face Mask

A cast was made of the face of a mannequin head using plaster. The plaster cast was then used as a mold for making a silicone rubber replica of a the mannequin face. All silicone rubber chemicals were purchased from NuSil Technologies (Carpinteria, Calif.).

A thin coat of Vaseline was applied to the inner surface of the plaster cast and the cast pre-warmed to 60° C. A 30 g:20 g:2.025 mL mixture of Silicone Gel Part A:Silicone Gel Part B:Silicone Polymer was mixed with 1 drop Silicone Catalyst and 2 tablespoons of Fiber Reinforcer. Silicone Gel Part A and Part B (P/N MED 6345) were obtained from NuSil Technologies. Air bubbles were removed from the silicone mixture by vacuum. The silicone mixture was added to the pre-warmed cast and spread evenly. The silicone mixture was placed in a convection oven at 60° C. for at least ten minutes.

A 80 g:80 g:2.4 mL mixture of Silicone Gel Part A:Silicone Gel Part B:Silicone Polymer was mixed with 3 drops Silicone Catalyst. 16 g of pigment and 160 g of Large Particle Extender (NaCl) was added to the mixture. After mixing, air bubbles were removed from the silicone mixture by vacuum. The silicone mixture was added to the pre-warmed cast with the first layer of silicone and spread evenly. A support mandrel was pushed into the second layer of silicone and the mold was heated for up to two hours at 60° C. The mask was removed from the mold and allowed to cure at room temperature for at least 24 hours. The mask was then ready for practice or demonstration injection of dermal filler material.

Other features and advantages of the present invention should be apparent from the following description of the disclosed embodiment, taken in conjunction with the accompanying drawings, which illustrate, by way of example, the principles of the invention. References cited herein are incorporated by reference.

The present invention has been described above in terms of various embodiments so that an understanding of the present invention can be conveyed. There are, however, many embodiments for life-like anatomic features not specifically described herein but with which the present invention is applicable. The present invention should therefore not be seen as limited to the particular embodiments described herein, but rather, those skilled in the art will appreciate that additional materials, techniques, or combinations of materials and techniques can be used to achieve the advantages of the invention. The invention is identified by the following claims.

We claim:

1. A life-like anatomic feature comprising low memory synthetic material.

2. The life-like anatomic feature of claim 1, wherein said low memory synthetic material is silicone rubber.

3. The life-like anatomic feature of claim 2, wherein said silicone rubber is made by mixing a silicone base with a catalyst.

4. The life-like anatomic feature of claim 3, wherein said catalyst is tin, platinum, gum elastomer, or peroxide.

5. The life-like anatomic feature of claim 3, wherein said catalyst is methyl ethyl ketone peroxide, benzyol peroxide or acetone peroxide.

6. The life-like anatomic feature of claim 2, wherein said silicone rubber includes a cross-linker.

7. The life-like anatomic feature of claim 6, wherein said cross-linker is silane-based.

8. The life-like anatomic feature of claim 1, further comprising an absorbent.

9. The life-like anatomic feature of claim 8, wherein said absorbent comprises one or more materials of glass fibers, carbon fibers, sand, salt, sugar, or foaming agent.

10. The life-like anatomic feature of claim 8, wherein said absorbent comprises at least one a gas.

11. The life-like anatomic feature of claim 1, wherein said life-like anatomic feature is formed in at least two layers.

12. The life-like anatomic feature of claim 1, wherein said life-like anatomic feature is formed in at least three layers.

13. The life-like anatomic feature of claim 1, wherein said life-like anatomic feature includes at least one pigment.

14. The life-like anatomic feature of claim 13, wherein said pigment is an inorganic pigment.

15. The life-like anatomic feature of claim 1, wherein said life-like anatomic feature includes one or more pigments to resemble the coloration of the corresponding anatomic feature.

16. The life-like anatomic feature of claim 1, wherein said anatomic feature includes at least one dye.

17. The life-like anatomic feature of claim 1, wherein said life-like anatomic feature includes one or more dyes to resemble the coloration of the corresponding anatomic feature.

18. The life-like anatomic feature of claim 1, wherein said life-like anatomic feature includes a coating.

19. The life-like anatomic feature of claim 18, wherein said coating is clear.

20. The life-like anatomic feature of claim 1, wherein said life-like anatomic feature has at least one representative defect.

21. The life-like anatomic feature of claim 1, wherein said life-like anatomic feature comprises a face mask.

22. The face mask of claim 21, wherein said face mask is a complete face.

23. The face mask of claim 21, wherein said face mask has at least one representative skin defect.

24. The face mask of claim 23, wherein said representative skin defect is a wrinkle, a fold, a thin lip, an irregularity of the nose, or an acne scar.

25. The life-like anatomic feature of claim 1, wherein said life-like anatomic feature represents a muscle.

26. The muscle representation of claim 25, wherein said muscle representation a sphincter muscle.

27. The sphincter muscle representation of claim 26, wherein said sphincter muscle representation is an anal sphincter, a urinary sphincter, a bladder sphincter, a lower esophageal sphincter, or a pyloric sphincter.

28. The muscle representation of claim 25, wherein said muscle has a defect.

29. The muscle representation of claim 28, wherein said defect is a tear.

30. The life-like anatomic feature of claim 1, wherein said life-like anatomic feature represents a body lumen.

31. The body lumen representation of claim 30, wherein said body lumen represents a blood vessel, a duct, a bronchus, a lung, a sinus, an esophagus, a stomach, a duodenum, a small intestine, a large intestine, a colon, a rectum, a ureter, a urethra, a vagina, or a fallopian tube.

32. The body lumen representation of claim 30, wherein said body lumen has a defect.

33. The body lumen representation of claim 32, wherein said defect is a tear or prolapse.

34. The life-like anatomic feature of claim 1, wherein said life-like anatomic feature represents the soft tissues of a joint.

35. The joint soft tissue representation of claim 34, wherein said joint is a temporomandibular joint, a shoulder, an elbow, a wrist, a finger joint, a hip, a knee, an ankle, or a toe joint.

36. The life-like anatomic feature of claim 1, wherein said life-like anatomic feature represents the soft tissue between vertebrae.

37. The soft tissue representation of claim 36, having a simulated disc injury.

38. The simulated disc injury of claim 37, wherein said simulated disc injury is soft disc herniation.

39. The simulated disc injury of claim 37, wherein said simulated disc injury is internal disc disruption.

40. A method of practicing using a soft tissue filler comprising:
injecting a soft tissue filler into a life-like anatomic feature comprising low memory synthetic material; and,
monitoring the change of the conformation of said life-like anatomic feature.

41. The method of claim 40, wherein said low memory synthetic material is silicone rubber.

42. The method of claim 41, wherein said silicone rubber is made by mixing a silicone base with a catalyst.

43. The method of claim 42, wherein said catalyst is tin, platinum, gum elastomer, or peroxide.

44. The method of claim 43, wherein said catalyst is methyl ethyl ketone peroxide, benzyol peroxide or acetone peroxide.

45. The method of claim 41, wherein said silicone rubber includes a cross-linker.

46. The method of claim 45, wherein said cross-linker is silane-based.

47. The method of claim 40, further comprising an absorbent.

48. The method of claim 47, wherein said absorbent comprises one or more of glass fibers, carbon fibers, sand, salt, sugar, or foaming agent.

49. The method of claim 47, wherein said absorbent comprises one or more gases.

50. The method of claim 40, wherein said life-like anatomic feature formed in at least two layers.

51. The method of claim 40, wherein said life-like anatomic feature is formed in at least three layers.

52. The method of claim 40, wherein said life-like anatomic feature has at least one representative defect.

53. The method of claim 40, wherein said life-like anatomic feature comprises a face mask.

54. The method of claim 53, wherein said face mask has at least one skin defect.

55. The method of claim 54, wherein said skin defect is a wrinkle, a fold, a thin lip, an irregularity of the nose, or an acne scar.

56. The method of claim 40, wherein said soft tissue filler comprises polymethylmethacrylate microspheres.

57. The method of claim 56, wherein said soft tissue filler comprises approximately 20% by weight PMMA and approximately 80% by weight a composition of 3.5% purified bovine collagen, 2.7% phosphate buffer, 0.9% sodium chloride, 0.3% lidocaine hydrochloride, and 92.6% water for injection.
